(19) United States
(12) Patent Application Publication
(10) Pub. No.: US 2003/0058842 A1
(43) Pub. Date: Mar. 27, 2003

(54) System and method for providing information services to a mobile device user

(76) Inventor: Andrew Bud, London (GB)

Correspondence Address: BROMBERG & SUNSTEIN LLP, 125 SUMMER STREET, BOSTON, MA, 02110-1618, US

(21) Appl. No.: 10/227,180

(22) Filed: Aug. 23, 2002

Related U.S. Application Data
(63) Continuation of application No. PCT/IB01/00551, filed on Feb. 22, 2001.
(60) Provisional application No. 60/184,759, filed on Feb. 24, 2000.

(51) Int. Cl. H04L 12/66

(52) U.S. Cl. 370/352

(57) ABSTRACT

A system and method for providing information services to a mobile device user, the mobile device user having a mobile device, comprising receiving profile information about the mobile device user; receiving real-time data from one or more content sources, the real-time data including forecast data; generating a message for the mobile device user, the message based on the received real-time data and tailored to substantially match at least part of the profile information of the mobile device user; and transmitting the tailored message to the mobile device of the mobile device user.

### CROSS REFERENCE TO RELATED APPLICATIONS

This application is a U.S. Continuation Application of the International Patent Cooperation Treaty Application No. PCT/IB01/00551 entitled “A SYSTEM AND METHOD FOR PROVIDING INFORMATION SERVICES TO A MOBILE DEVICE USER” filed on Feb. 22, 2001, which claims priority from U.S. Provisional Patent Application No. 60/184,759, filed Feb. 24, 2000, entitled “APPARATUS AND METHOD FOR PROVIDING CUSTOMER INFORMATION SERVICES”, both disclosures of which are incorporated herein, in their entirety, by reference.

### TECHNICAL FIELD AND BACKGROUND ART

The invention generally relates to information services and, more particularly, the invention relates to information services for mobile device users.

At present, mobile telecommunications users represent a large, and growing, percentage of all telecommunication users. These “mobile” users use their mobile telephones, pagers, personal digital assistants, and mobile computers for business and pleasure, communicating, for example, with employers, family, and clients. As a result, various mobile telecommunication services have been developed to meet the needs of these mobile device users. For example, in addition to standard voice-to-voice communication services, mobile device-to-mobile device services have been developed.

One such service, referred to as Short Message Service (“SMS”), allows mobile device users to transmit short messages from, for example, one mobile telephone to another mobile telephone. In SMS, messages are routed from the sending mobile device to a SMS Service Center (“SMSC”). The SMSC then routes the message to the receiving mobile device. Another service, referred to as Wireless Application Protocol (“WAP”), allows mobile device users to access World Wide Web applications from their mobile devices. In WAP, a “condensed” version of Hyper Text Markup Language (“HTML”) is used, referred to as Wireless Markup Language (“WML”).

### SUMMARY OF THE INVENTION

In accordance with one aspect of the invention, a system and method for providing information services to a mobile device user, the mobile device user having a mobile device, receives profile information about the mobile device user, receives real-time data from one or more content sources, generates a message for the mobile device user, the message based on the received real-time data and tailored to substantially match at least part of the profile information of the mobile device user, and transmits the tailored message to the mobile device of the mobile device user.

In accordance with another aspect of the invention, a system and method for providing travel information to a mobile device user, the mobile device user having a mobile device, receives profile information about the mobile device user, the profile information including itinerary information for the mobile device user, receives real-time data from one or more content sources, the real-time data including route and vehicle information, generates a message for the mobile device user, the message based on the received real-time data and tailored to substantially match at least part of the profile information of the mobile device user, the generated message including status information tailored to the itinerary of the mobile device user, and transmits the generated message to the mobile device of the mobile device user.

In further embodiments of this aspect of the invention, the route and vehicle information may be information on a vehicle delay on a particular route, information on a vehicle cancellation on a particular route, or information on a route change for a particular vehicle. In addition, the status information may be information on a vehicle on a particular route or information on alternate transportation.

In a further embodiment of both aspects of the invention, the system and method receives a message from the mobile device user in response to the tailored message. In a still further embodiment of both aspects of the invention, the system and method transmits a reply message to the mobile device user, the reply message responsive to the received response message.

In alternate embodiments of both aspects of the invention, the system and method receives the profile information from the mobile device user or an entity acting on behalf of the mobile device user. In addition, the mobile device user or the entity acting on behalf of the mobile device user uses a computer network, a telecommunications network, the World Wide Web, an electronic mail system, a facsimile machine, an interactive voice response system, or a customer service call center to send the profile information. Further, the one or more content sources may be a retailer, a manufacturer, a health care provider, a transportation provider, a service provider, an education provider, a travel provider, or an entertainment provider. Also, the real-time data may be sent as an automatic process, a manual process, or a combination of an automatic process and a manual process. The manual process real-time data may be forecast data, which may augment the automatic process real-time data.

In other alternate embodiments of both aspects of the invention, the mobile device may be a mobile telephone, a personal digital assistant, a pager, or a mobile computer. Further, the system and method transmits the tailored message using a mobile telecommunications message system. The mobile telecommunications message system may be Short Message Service, General Packet Radio Service, Universal Mobile Telecommunications System, Bluetooth, or Wireless Application Protocol. The profile information may include identification information for the mobile device user, identification information for the mobile device user's mobile device, and identification information for the mobile device user's subscription service.

### BRIEF DESCRIPTION OF THE DRAWINGS

The foregoing features of the invention will be more readily understood by reference to the following detailed description, taken with reference to the accompanying drawings, in which:

FIG. 1 shows a flowchart of an exemplary process for implementing various embodiments of an information services system for mobile device users.

FIG. 2 shows a functional diagram of an exemplary system for implementing various embodiments of an information services system for mobile device users.

FIG. 3 shows an exemplary platform architecture for implementing various embodiments of an information services system for mobile device users.

FIG. 4 shows a flowchart of an exemplary process for implementing various embodiments of a travel information services system for mobile device users.

### DETAILED DESCRIPTION OF SPECIFIC EMBODIMENTS

In accordance with one embodiment of the invention, an information services system provides mobile device users with real-time, personalized information from one or more content sources. This information services system, also referred to as a media channel, is scaleable, offering personalized service to millions of mobile device users.

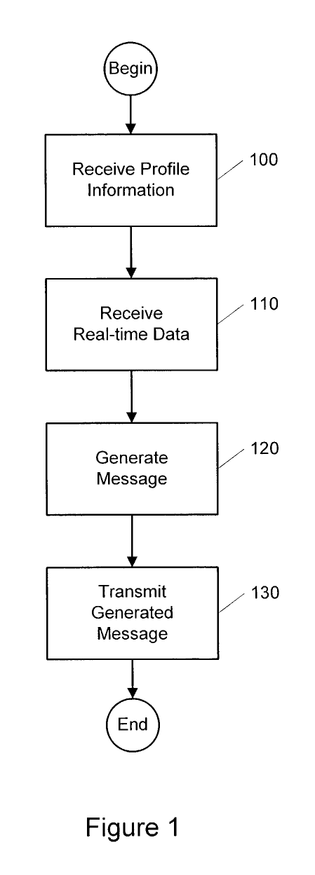

FIG. 1 shows a flowchart of an exemplary process for implementing various embodiments of an information services system for mobile device users. The process begins at step 100, in which the system receives profile information about one or more mobile device users. The profile information may include information about the mobile device user, information about the mobile device user's mobile device, and information about the mobile device user's subscription service. For example, the mobile device user information may include information that identifies the mobile device user, such as the mobile device user's name or account number. The mobile device information may include information that identifies the mobile device, such as the type of mobile device or the manufacturer of the mobile device. The subscription service information may include information that identifies the name of the telecommunications company providing mobile communications to the mobile device, or the number (for example, the telephone number or the access number) of the mobile device.

The profile information may also include information regarding the types of information the mobile device user wants to receive, when the mobile device user wants to receive the information, or how the mobile device user wants to receive the information. In general, these types of information vary in accordance with the specific application of the information services system.

The process continues at step 110, in which the system receives real-time data from one or more content sources. The content sources may be, for example, a retailer (such as a clothing retailer), a manufacturer (such as an automobile manufacturer), a transportation provider (such as an airline operator), a health care provider (such as a medical clinic), a service provider (such as a contractor), an education provider (such as a school), a travel provider (such as a travel agent), or an entertainment provider (such as a game maker). The real-time data may be received via an automatic process or a manual process. For example, a health care provider may send the information services system patient appointment information via an automated process, but may send “breaking” medical news via a manual process.

Next, at step 120, the system generates a message for the mobile device user. The generated message is based on the received real-time data and is tailored to substantially match at least part of the profile information of the mobile device user. For example, in the health care provider example discussed above, the generated message may be a reminder of an upcoming appointment, breaking medical news about a medical condition, or information about the health care provider's planned office closing due to a vacation.

Last, at step 130, the system transmits the generated message to the mobile device user's mobile device. For example, the system may transmit the generated message to the mobile device user's mobile telephone as a Short Message Service (“SMS”) message.

In further embodiments of the invention, mobile device users may also modify their profile information or send a termination notice to the system. The termination notice might request termination of the information service on a permanent basis or on a temporary basis. For example, a mobile device user may not want to receive the information service during his or her vacation.

In a still further embodiment of the invention, the system may send a confirmation message to the mobile device users at the time the mobile device users send the system their profile information. The confirmation message may request a mobile device user to confirm that he or she has sent their profile information to the system. This additional process protects against “malicious” transmissions of profile information to the system.

In another further embodiment of the invention, a mobile device user may reply to the generated message. In turn, the system may send a message responsive to the reply message to the mobile device user.

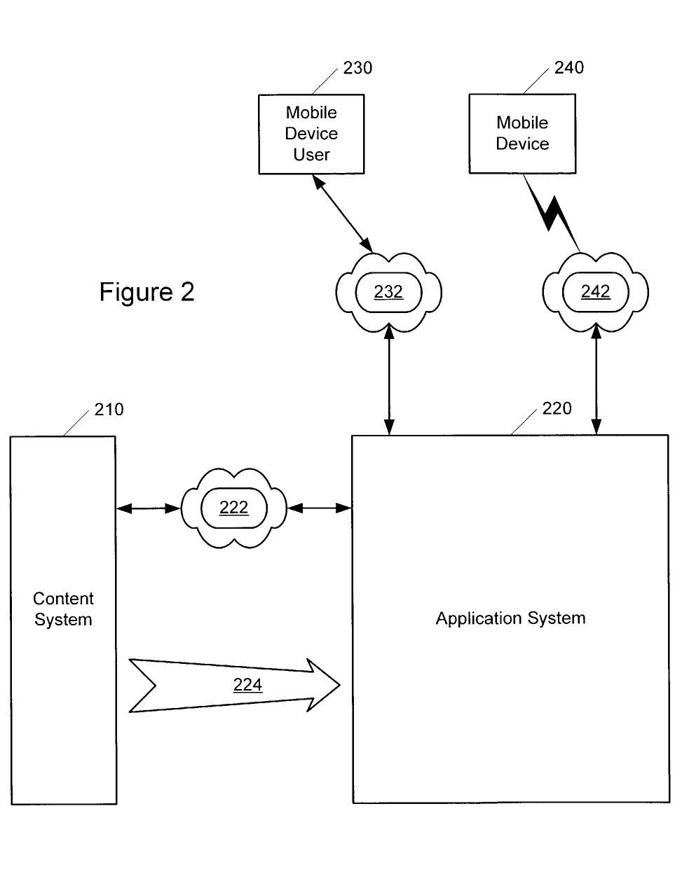

FIG. 2 shows a functional diagram of an exemplary system for implementing various embodiments of an information services system for mobile device users. In the exemplary system, content system 210 is connected to application system 220 via portal 222 and/or portal 224. In turn, application system 220 is connected to mobile device users 230 via portal 232 and the mobile device users' mobile devices 240 via portal medium 242. The term “portal” encompasses many and varied communication “systems.” For example, a portal may be the Internet, an Intranet, an Extranet, the World Wide Web, a computer network, a telecommunications network, a dedicated line, a modem, or an SMS Service Center (“SMSC”). A portal may also be a communications protocol, such as Transport Control Protocol (“TCP”), Internet Protocol (“IP”), TCP/IP, SMS, or Wireless Application Protocol (“WAP”).

In operation, mobile device users 230 send profile information to application system 220 via portal 232. Portal 232 may be, for example, the Internet, the World Wide Web, an Interactive Voice Response (“IVR”) system, an electronic mail system, a facsimile machine, or a customer service center. In a similar manner, content system 210 sends real-time data to application system 220 via portal 222 and/or portal 224. Portal 222 may be, for example, the Internet, the World Wide Web, an Intranet, or an Extranet. In contrast, portal 224 may be, for example, an ethernet connection, a high-speed telephone connection, or a dedicated line. In an exemplary embodiment in which content system 210 sends real-time data via a combination of an automatic process and a manual process, and in which portal 222 is an Intranet and portal 224 is an ethernet connection, then content system 210 may send the manual process real-time data via portal 222 and the automatic process real-time data via portal 224.

In turn, application system 220 uses a mobile device user's profile information and the real-time data to generate a tailored message for the mobile device user. Then, application system 220 transmits the generated message to the mobile device user's mobile device via portal 242. The message may be transmitted upon generation of the message, or the message may be held for later transmission. The mobile device user's mobile device may be, for example, a mobile telephone, a personal digital assistance, a pager, or a mobile computer (for example, a hand-held computer or a laptop computer). Portal 242 may be, for example, a SMS message, a WAP transmission, a streaming media transmission, a General Packet Radio Service transmission, a Universal Mobile Telecommunications System transmission, or a Bluetooth transmission.

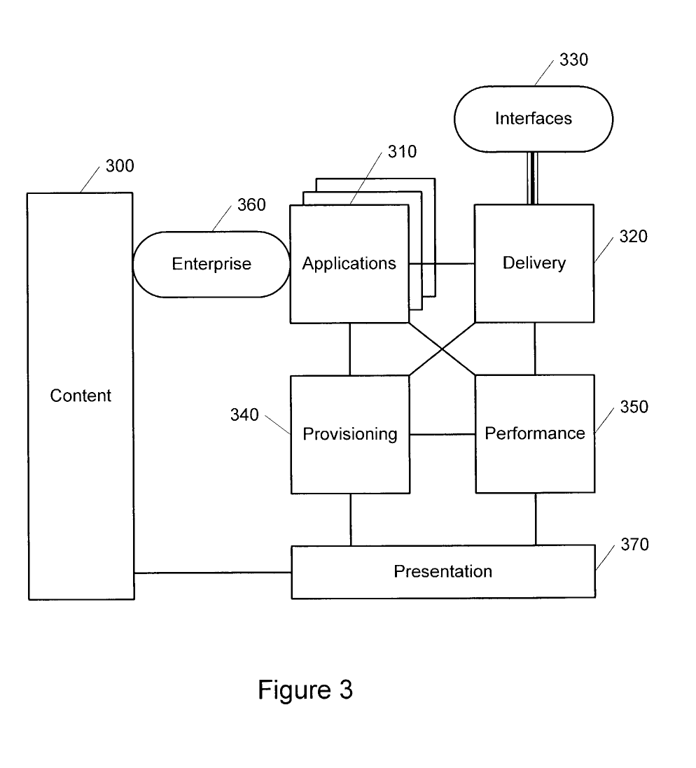

FIG. 3 shows an exemplary platform architecture for implementing various embodiments of an information services system for mobile device users. The exemplary platform architecture comprises numerous modules which substantially mirror the system's operation, such as content module 300, applications module 310, delivery module 320, and interfaces module 330. In addition, the platform architecture comprises a module for ensuring the system will scale, provisioning module 340, and a module for managing the performance of delivery module 320, performance module 350. The platform architecture also includes a module for integrating enterprise applications, enterprise module 360, and a module for communicating with mobile device users and content sources, presentation module 370.

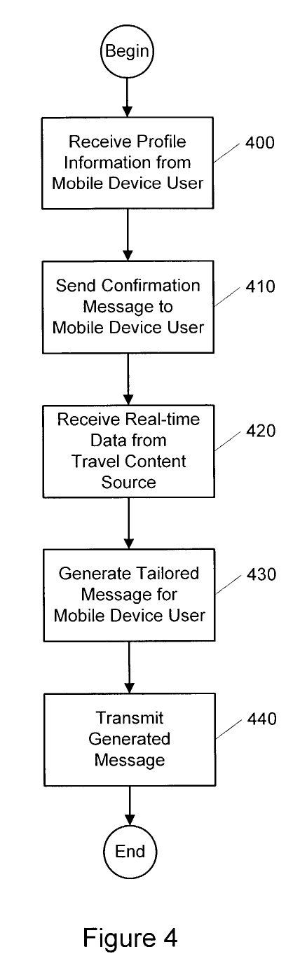

FIG. 4 shows a flowchart of an exemplary process for implementing various embodiments of a travel information services system for mobile device users. For example, the exemplary travel information services system may be used to keep commuters informed of commuter train, commuter bus, or commuter boat schedules—including vehicle delays on a particular route, vehicle cancellations on a particular route, or route changes for a particular vehicle. The exemplary travel information services system may also be used to keep travelers informed of airline, railroad, bus, limousine, or ship schedules—including vehicle delays on a particular route, vehicle cancellations on a particular route, or route changes for a particular vehicle.

The process begins at step 400, in which the system receives profile information from a mobile device user. In a commuter implementation, the profile information might include mobile device information, as well as route and vehicle information. For example, mobile device user B wants schedule information, sent to his mobile telephone via a SMS message, for the 7:15 a.m. commuter train (a vehicle) from A to B (a route). The mobile device user also wants schedule information for the 5:45 p.m. commuter train (a vehicle) from B to A (a route). Mobile device user B wants to receive the relevant schedule information 30 minutes prior to the vehicles' scheduled departures.

The process continues at step 410, in which the system sends a confirmation message to the mobile device user, requesting confirmation that the mobile device user sent the profile information to the system. Typically, the confirmation message is sent to the mobile device user's mobile device. In the interim, at step 420, the system receives real-time schedule data from a travel content source. The real-time schedule data may be sent to the system via an automatic process and/or a manual process. For example, the automatic process may send “routine” schedule information, including running delay information, to the system. In contrast, the manual process may send to the system “forecasted” changes to the schedule. The forecasts may be, for example, minute-by-minute forecasts of how operational conditions may affect the timing of each vehicle on each route within the next hour. Typically, the forecasts augment the routine schedule information, which may include running delay information.

In general, in this exemplary embodiment, the manual process real-time data might not be sent via an automatic process due to, for example, the immediacy of the real-time data. In addition, the manual process real-time data might be uniquely within the knowledge of, for example, a travel operator who, based on human experience, may be better able to forecast a schedule change than, for example, an artificial intelligence system.

When appropriate, at step 430, the system uses a mobile device user's profile information and the real-time data to generate a tailored message for the mobile device user. For example, continuing the commuter example discussed above, the system receives schedule information from the commuter rail operator that, on this Wednesday morning, the 7:15 a.m. commuter train from A to B is running 10 minutes late. In response, the system generates a message for mobile device user B, sometime prior to 6:45 a.m., that informs him about the commuter train's delay. The message might read: “Mr. Smith, as of 6:30 a.m. today, your 7:15 a.m. train from A to B is running 5-10 minutes late (6:45 a.m.).” In this example, the time within the parenthesis shows the time the message was sent to mobile device user B.

Last, at step 440, the system sends the generated message to the mobile device user's mobile device. For example, in the commuter example discussed above, the system sends the generated message at 6:45 a.m. to mobile device user B's mobile telephone via a SMS message. Depending upon mobile device user B's selection, the SMS message might flash on mobile device user B's mobile telephone, or the SMS message might be sent to an “in-box” on mobile device user B's mobile telephone.

In a further embodiment of the travel information services system, the mobile device user may send a reply message to the system seeking, for example, information on the reasons for the commuter train's delay. In turn, the system sends a message responsive to the reply message informing the mobile device user of, for example, the reason for the commuter train's delay.

In a still further embodiment of the travel information services system, the system may send the mobile device user an “events-driven” message, as well as the scheduled-time message. For example, in continuing the commuter rail example discussed above, the system receives subsequent schedule information from the commuter rail operator data about the 7:15 a.m. commuter train from A to B. The subsequent schedule information states that the 7:15 a.m. commuter train from A to B is running 45 minutes late. In response, the system generates a message for mobile device user B, sometime subsequent to 6:45 a.m., that informs him about the commuter train's additional delay. The message might read: “Mr. Smith, as of 7:05 a.m. today, your 7:15 a.m. train from A to B is running 30-45 minutes late (7:06 a.m.).”

In an alternate embodiment of a travel information services system for mobile device users, the travel content source may be, for example, an airline operator. In this exemplary embodiment, a mobile device user may provide the relevant profile information to, for example, a travel agent, when he or she makes a travel reservation or purchases travel tickets. Thus, in this alternate embodiment, the travel information services system receives the mobile device user's profile information from an entity acting on behalf of the mobile device user. The entity may be, for example, the travel agent or the travel content source. The profile information may include, for example, information about the mobile device user's mobile device, information regarding the types of information the mobile device user wants to receive, when the mobile device user wants to receive the information, or how the mobile device user wants to receive the information.

These scheduled-time and events-driven messages give a travel content source a flexible, dynamic mechanism for keeping its customers informed about schedule changes, as well as how to best travel from one destination to another destination under many different types of circumstances. For example, a message might inform a mobile device user of alternate transportation, such as whether it is better, on a particular route, to take a nominally later scheduled vehicle than a nominally earlier scheduled vehicle because the later scheduled vehicle will deliver the mobile device user to his or her destination sooner than the earlier scheduled vehicle. Or, a message might inform a mobile device user that a specific transportation vehicle, such as a particular commuter train, is unavailable and suggest, for example, that the mobile device user take a different specific transportation vehicle, such as a particular commuter bus.

The various embodiments of the invention may be implemented in any conventional computer programming language. For example, the various embodiments may be implemented in a procedural programming language (for example, “C”) or an object-oriented programming language (for example, “C++” or JAVA). The various embodiments of the invention may also be implemented as preprogrammed hardware elements (for example, application specific integrated circuits or digital processors), or other related components.

The various embodiments of the invention may be also implemented as a computer program product for use with a computer system. Such implementation may include a series of computer instructions fixed either on a tangible medium, such as a computer readable media (for example, a diskette, CD_ROM, ROM, or fixed disk), or transmittable to a computer system via a modem or other interface device, such as a communications adapter connected to a network over a medium. The medium may be either a tangible medium (for example, optical or analog communications lines) or a medium implemented with wireless techniques (for example, microwave, infrared or other transmission techniques). The series of computer instructions preferably embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), pre_loaded with a computer system (for example, on system ROM or fixed disk), or distributed from a server or electronic bulletin board over the network (for example, the Internet or the World Wide Web).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A method for providing information services to a mobile device user, the mobile device user having a mobile device, the method comprising:
receiving profile information about the mobile device user;
receiving real-time data from one or more content sources, the real-time data including forecast data;
generating a message for the mobile device user, the message based on the received real-time data and tailored to substantially match at least part of the profile information of the mobile device user; and
transmitting the tailored message to the mobile device of the mobile device user.

2. The method according to claim 1 wherein the real-time data is sent via X, wherein X is an automatic process, a manual process, or a combination of an automatic process and a manual process.

3. The method according to claim 1, further comprising:
receiving a message from the mobile device user in response to the tailored message.

4. The method according to claim 3, further comprising:
transmitting a reply message to the mobile device user, the reply message responsive to the received response message.

5. The method according to claim 1 wherein the process for receiving profile information receives the profile information from I, wherein I is the mobile device user or an entity acting on behalf of the mobile device user.

6. The method according to claim 5 wherein I uses S to send the profile information, wherein S is a computer network, a telecommunications network, the World Wide Web, an electronic mail system, a facsimile machine, an interactive voice response system, or a customer service call center.

7. The method according to claim 1 wherein the one or more content sources include C, wherein C is a retailer, a manufacturer, a health care provider, a transportation provider, a service provider, an education provider, a travel provider, or an entertainment provider.

8. The method according to claim 1 wherein the mobile device is M, wherein M is a mobile telephone, a personal digital assistant, a pager, or a mobile computer.

9. The method according to claim 1 wherein the process for transmitting the tailored message transmits the tailored message using a mobile telecommunications message system.

10. The method according to claim 9 wherein the mobile telecommunications message system includes P, wherein P is Short Message Service, General Packet Radio Service, Universal Mobile Telecommunications System, Bluetooth, or Wireless Application Protocol.

11. The method according to claim 1 wherein the profile information includes P, wherein P is identification information for the mobile device user, identification information for the mobile device user's mobile device, or identification information for mobile device user's subscription service.

12. A system for providing information services to a mobile device user, the mobile device user having a mobile device, the system comprising:
a module for receiving profile information about the mobile device user;
a module for receiving real-time data from one or more content sources, the real-time data including forecast data;
a module for generating a message for the mobile device user, the message based on the received real-time data and tailored to substantially match at least part of the profile information of the mobile device user; and
a module for transmitting the tailored message to the mobile device of the mobile device user.

13. The system according to claim 12 wherein the real-time data is sent via X, wherein X is an automatic process, a manual process, or a combination of an automatic process and a manual process.

14. The system according to claim 12, further comprising:
a module for receiving a message from the mobile device user in response to the tailored message.

15. The system according to claim 14, further comprising:
a module for transmitting a reply message to the mobile device user, the reply message responsive to the received response message.

16. The system according to claim 12 wherein the module for receiving profile information receives the profile information from I, wherein I is the mobile device user or an entity acting on behalf of the mobile device user.

17. The system according to claim 16 wherein I uses S to send the profile information, wherein S is a computer network, a telecommunications network, the World Wide Web, an electronic mail system, a facsimile machine, an interactive voice response system, or a customer service call center.

18. The system according to claim 12 wherein the one or more content sources include C, wherein C is a retailer, a manufacturer, a health care provider, a transportation provider, a service provider, an education provider, a travel provider, or an entertainment provider.

19. The system according to claim 12 wherein the mobile device is M, wherein M is a mobile telephone, a personal digital assistant, a pager, or a mobile computer.

20. The system according to claim 12 wherein the module for transmitting the tailored message transmits the tailored message using a mobile telecommunications message system.

21. The system according to claim 20 wherein the mobile telecommunications message system includes P, wherein P is Short Message Service, General Packet Radio Service, Universal Mobile Telecommunications System, Bluetooth, or Wireless Application Protocol.

22. The system according to claim 12 wherein the profile information includes P, wherein P is identification information for the mobile device user, identification information for the mobile device user's mobile device, or identification information for mobile device user's subscription service.

23. A computer program product for providing information services to a mobile device user, the mobile device user having a mobile device, the computer program product comprising a computer usable medium having a computer readable program code thereon, the computer program code comprising:
program code for receiving profile information about the mobile device user;
program code for receiving real-time data from one or more content sources, the real-time data including forecast data;
program code for generating a message for the mobile device user, the message based on the received real-time data and tailored to substantially match at least part of the profile information of the mobile device user; and
program code for transmitting the tailored message to the mobile device of the mobile device user.

24. The computer program product according to claim 23 wherein the real-time data is sent via X, wherein X is an automatic process, a manual process, or a combination of an automatic process and a manual process.

25. The computer program product according to claim 23, further comprising:
program code for receiving a message from the mobile device user in response to the tailored message.

26. The computer program product according to claim 25, further comprising:
program code for transmitting a reply message to the mobile device user, the reply message responsive to the received response message.

27. The computer program product according to claim 23 wherein the program code for receiving profile information receives the profile information from I, wherein I is the mobile device user or an entity acting on behalf of the mobile device user.

28. The computer program product according to claim 27 wherein I uses S to send the profile information, wherein S is a computer network, a telecommunications network, the World Wide Web, an electronic mail system, a facsimile machine, an interactive voice response system, or a customer service call center.

29. The computer program product according to claim 23 wherein the one or more content sources include C, wherein C is a retailer, a manufacturer, a health care provider, a transportation provider, a service provider, an education provider, a travel provider, or an entertainment provider.

30. The computer program product according to claim 23 wherein the mobile device is M, wherein M is a mobile telephone, a personal digital assistant, a pager, or a mobile computer.

31. The computer program product according to claim 23 wherein the program code for transmitting the tailored message transmits the tailored message using a mobile telecommunications message system.

32. The computer program product according to claim 31 wherein the mobile telecommunications message system includes P, wherein P is Short Message Service, General Packet Radio Service, Universal Mobile Telecommunications System, Bluetooth, or Wireless Application Protocol.

33. The computer program product according to claim 23 wherein the profile information includes P, wherein P is identification information for the mobile device user, identification information for the mobile device user's mobile device, or identification information for mobile device user's subscription service.

34. A media channel for providing information services to a mobile device user, the mobile device user having a mobile device, the media channel comprising:
means for receiving profile information about the mobile device user;
means for receiving real-time data from one or more content sources, the real-time data including forecast data;
means for generating a message for the mobile device user, the message based on the received real-time data and tailored to substantially match at least part of the profile information of the mobile device user; and
means for transmitting the tailored message to the mobile device of the mobile device user.

35. The media channel according to claim 34 wherein the real-time data is sent via X, wherein X is an automatic process, a manual process, or a combination of an automatic process and a manual process.

36. The media channel according to claim 34, further comprising:
means for receiving a message from the mobile device user in response to the tailored message.

37. The media channel according to claim 36, further comprising:
means for transmitting a reply message to the mobile device user, the reply message responsive to the received response message.

38. The media channel according to claim 34 wherein the means for receiving profile information receives the profile information from I, wherein I is the mobile device user or an entity acting on behalf of the mobile device user.

39. The media channel according to claim 38 wherein I uses S to send the profile information, wherein S is a computer network, a telecommunications network, the World Wide Web, an electronic mail system, a facsimile machine, an interactive voice response system, or a customer service call center.

40. The media channel according to claim 34 wherein the one or more content sources include C, wherein C is a retailer, a manufacturer, a health care provider, a transportation provider, a service provider, an education provider, a travel provider, or an entertainment provider.

41. The media channel according to claim 34 wherein the mobile device is M, wherein M is a mobile telephone, a personal digital assistant, a pager, or a mobile computer.

42. The media channel according to claim 34 wherein the means for transmitting the tailored message transmits the tailored message using a mobile telecommunications message system.

43. The media channel according to claim 42 wherein the mobile telecommunications message system includes P, wherein P is Short Message Service, General Packet Radio Service, Universal Mobile Telecommunications System, Bluetooth, or Wireless Application Protocol.

44. The media channel according to claim 34 wherein the profile information includes P, wherein P is identification information for the mobile device user, identification information for the mobile device user's mobile device, or identification information for mobile device user's subscription service.

45. A method for providing travel information services to a mobile device user, the mobile device user having a mobile device, the method comprising:
receiving profile information about the mobile device user, the profile information including itinerary information for the mobile device user;
receiving real-time data from one or more content sources, the real-time data including forecasted route and vehicle information;
generating a message for the mobile device user, the message based on the received real-time data and tailored to substantially match at least part of the profile information of the mobile device user, the generated message including status information tailored to the itinerary of the mobile device user; and
transmitting the generated message to the mobile device of the mobile device user.

46. The method according to claim 45, further comprising:
receiving a message from the mobile device user in response to the tailored message.

47. The method according to claim 46, further comprising:
transmitting a reply message to the mobile device user, the reply message responsive to the received response message.

48. The method according to claim 45 wherein the process for receiving profile information receives the profile information from I, wherein I is the mobile device user or an entity acting on behalf of the mobile device user.

49. The method according to claim 48 wherein the mobile device user uses S to send the profile information, wherein S is the World Wide Web, an interactive voice response system, or a customer service call center.

50. The method according to claim 45 wherein the one or more content sources include C, wherein C is a rail operator, an airline operator, a ship operator, a limousine operator, or a bus operator.

51. The method according to claim 45 wherein the real-time data is sent via X, wherein X is an automatic process, a manual process, or a combination of an automatic process and a manual process.

52. The method according to claim 51 wherein the manual process real-time data is the forecast data, the forecast data augmenting the automatic process real-time data.

53. The method according to claim 45 wherein the mobile device is a mobile telephone.

54. The method according to claim 45 wherein the process for transmitting the generated message transmits the generated message using a mobile telecommunications message system.

55. The method according to claim 54 wherein the mobile telecommunications message system is Short Message Service.

56. The method according to claim 45 wherein the profile information includes P, wherein P is identification information for the mobile device user, identification information for the mobile device user's mobile device, or identification information for mobile device user's subscription service.

57. The method according to claim 45 wherein the forecasted route and vehicle information includes V, wherein V is information on a vehicle delay on a particular route, information on a vehicle cancellation on a particular route, or information on a route change for a particular vehicle.

58. The method according to claim 45 wherein the status information includes S, wherein S is information on a vehicle on a particular route or information on alternate transportation.

59. A system for providing travel information to a mobile device user, the mobile device user having a mobile device, the system comprising:
a first receiver for receiving profile information about the mobile device user, the profile information including itinerary information for the mobile device user;
a second receiver for receiving real-time data from one or more content sources, the real-time data including forecasted route and vehicle information;
a generator for generating a message for the mobile device user, the message based on the received real-time data and tailored to substantially match at least part of the profile information of the mobile device user, the generated message including status information tailored to the itinerary of the mobile device user; and
a first transmitter for transmitting the generated message to the mobile device of the mobile device user.

60. The system according to claim 59, further comprising:
a third receiver for receiving a message from the mobile device user in response to the tailored message.

61. The system according to claim 60, further comprising:
a second transmitter for transmitting a reply message to the mobile device user, the reply message responsive to the received response message.

62. The system according to claim 59 wherein the first receiver for receiving profile information receives the profile information from I, wherein I is the mobile device user or an entity acting on behalf of the mobile device user.

63. The system according to claim 62 wherein the mobile device user uses S to send the profile information, wherein S is the World Wide Web, an interactive voice response system, or a customer service call center.

64. The system according to claim 59 wherein the one or more content sources include C, wherein C is a rail operator, an airline operator, a ship operator, a limousine operator, or a bus operator.

65. The system according to claim 59 wherein the real-time data is sent via X, wherein X is an automatic process, a manual process, or a combination of an automatic process and a manual process.

66. The system according to claim 65 wherein the manual process real-time data is the forecast data, the forecast data augmenting the automatic process real-time data.

67. The system according to claim 59 wherein the mobile device is a mobile telephone.

68. The system according to claim 59 wherein the first transmitter for transmitting the generated message transmits the generated message using a mobile telecommunications message system.

69. The system according to claim 68 wherein the mobile telecommunications message system is Short Message Service.

70. The system according to claim 59 wherein the profile information includes P, wherein P is identification information for the mobile device user, identification information for the mobile device user's mobile device, or identification information for mobile device user's subscription service.

71. The system according to claim 59 wherein the forecasted route and vehicle information includes V, wherein V is information on a vehicle delay on a particular route, information on a vehicle cancellation on a particular route, or information on a route change for a particular vehicle.

72. The system according to claim 59 wherein the status information includes S, wherein S is information on a vehicle on a particular route or information on alternate transportation.
